(19) United States
(12) Patent Application Publication
(10) Pub. No.: US 2010/0157481 A1
(43) Pub. Date: Jun. 24, 2010

(54) MAGNETIC DISK DRIVE

(75) Inventor: Masaya KUDO, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/643,795

(22) Filed: Dec. 21, 2009

(30) Foreign Application Priority Data
Dec. 22, 2008 (JP) 2008-326227

(51) Int. Cl. G11B 5/48

(52) U.S. Cl. 360/245.3; G9B/5.147

(57) ABSTRACT

According to one embodiment, a magnetic disk drive includes a magnetic disk including a recording surface, a head gimbal assembly including a slider in which a head is incorporated and a tab, and a ramp in a vicinity of the magnetic disk, the ramp including a first counter surface opposed to a peripheral part of the magnetic disk, a second counter surface opposed to an edge surface of the magnetic disk, and a ramp edge, in which the ramp includes a part of a side surface which is adjacent to the first counter surface and faces to a rotating direction of the magnetic disk, and is recessed toward a downstream side in the rotating direction of the magnetic disk, and the part of the side surface which is recessed and a tangent line to an outer circumference of the magnetic disk form an acute angle.

### CROSS-REFERENCE TO RELATED APPLICATIONS

This application is based upon and claims the benefit of priority from Japanese Patent Application No. 2008-326227, filed Dec. 22, 2008, the entire contents of which are incorporated herein by reference.

### BACKGROUND

1. Field

One embodiment of the present invention relates to a magnetic disk drive comprising an improved ramp.

2. Description of the Related Art

A magnetic disk drive comprises a magnetic disk, and a head gimbal assembly. The magnetic disk has a recording surface and is rotatably supported. The head gimbal assembly causes a head to access the recording surface of the magnetic disk. The magnetic disk drive is also provided with a ramp for unloading the head to the outside of the magnetic disk when the magnetic disk drive is stopped or when a read or write operation is suspended. The ramp is provided in the vicinity of the magnetic disk, and comprises a first counter surface opposed to a peripheral part of the recording surface of the magnetic disk, a second counter surface opposed to the edge surface of the magnetic disk, and a ramp edge which causes a tab (lift tab) provided on the tip end of the head gimbal assembly to lift in a sliding manner. The ramp is formed of a resin-molded product.

When strong impact externally acts on the magnetic disk drive, the magnetic disk may bend due to the impact and may collide with the first counter surface of the ramp. As a result, ground dust of the resin constituting the ramp may be produced, which sticks to the peripheral part of the magnetic disk. If such ground dust scatters onto the inner recording surface of the magnetic disk, the ground dust may cause the magnetic head and the magnetic disk to fail.

In order to address the problem described above, Jpn. Pat. Appln. KOKAI Publication No. 2006-323939 discloses a ramp in which a space for allowing the outer peripheral part of the magnetic disk to escape is provided on the side of the second counter surface opposed to the edge surface of the magnetic disk. Such a configuration aims for preventing the outer peripheral part of the magnetic disk from making contact with the ramp when the magnetic disk bends due to external impact. However, even such a configuration cannot eliminate contact of the outer peripheral part of the magnetic disk with the ramp.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view of a magnetic disk drive according to an embodiment of the present invention;

FIG. 2 is a perspective view of a head stack assembly (HSA) of a magnetic disk drive according to an embodiment of the invention;

FIG. 3 is a perspective view showing an appearance of a ramp as a load/unload mechanism of a magnetic disk drive according to an embodiment of the invention;

FIG. 4A is a plan view of a conventional ramp and magnetic disk, and FIGS. 4B and 4C are cross-sectional views thereof;

FIG. 5 is a perspective view showing a ramp and magnetic disk in a magnetic disk drive according to an embodiment of the invention;

FIGS. 6A and 6B are side views of the ramp according to the embodiment of the invention;

FIGS. 7A, 7B and 7C are perspective views of the ramp according to the embodiment of the invention, sectioned along levels L1, L2, and L3 in FIG. 6B, respectively;

FIGS. 8A and 8B are a plan view and a cross-sectional view of the ramp in the magnetic disk drive according to the embodiment of the invention;

FIG. 9 is a perspective view showing a ramp according to another embodiment of the invention, sectioned along the level L2 in FIG. 6B; and

FIGS. 10A and 10B are a plan view and a cross-sectional view of a ramp and magnetic disk according to still another embodiment of the invention.

### DETAILED DESCRIPTION

Various embodiments according to the invention will be described hereinafter with reference to the accompanying drawings. In general, according to one embodiment of the invention, there is provided a magnetic disk drive comprising: a magnetic disk comprising a recording surface, the magnetic disk being rotatably supported; a head gimbal assembly comprising a slider in which a head is incorporated and a tab, the head gimbal assembly being configured to cause the head to access the recording surface of the magnetic disk; and a ramp in a vicinity of the magnetic disk, the ramp comprising a first counter surface opposed to a peripheral part of the magnetic disk, a second counter surface opposed to an edge surface of the magnetic disk, and a ramp edge configured to cause the tab of the head gimbal assembly to slide, wherein the ramp comprises a part of a side surface which is adjacent to the first counter surface and faces to a rotating direction of the magnetic disk, and is recessed toward a downstream side in the rotating direction of the magnetic disk, and wherein the part of the side surface which is recessed and a tangent line to an outer circumference of the magnetic disk form an acute angle.

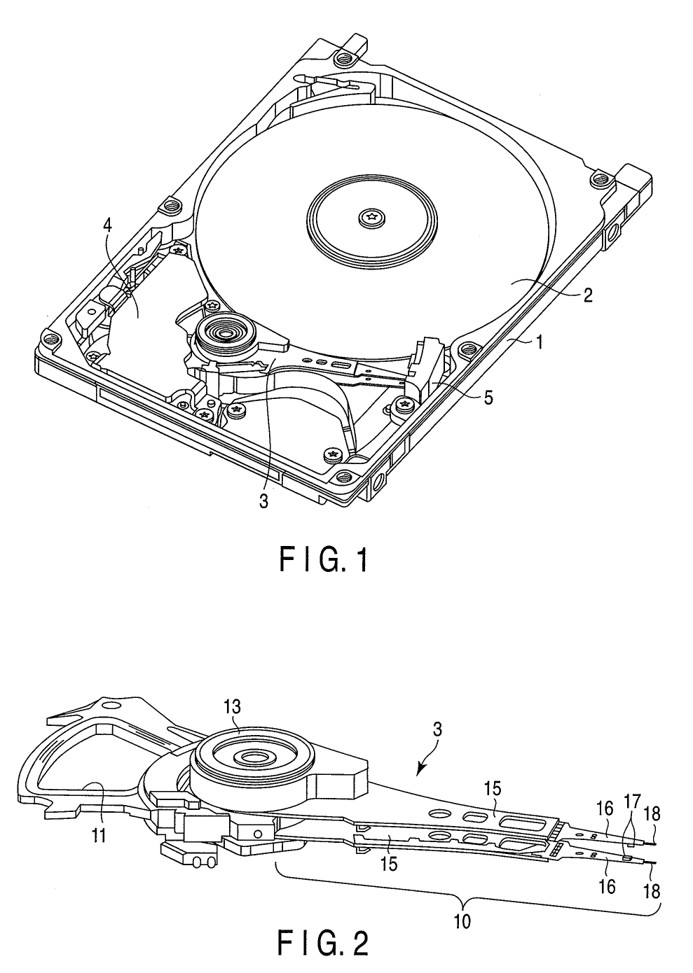

FIG. 1 is a perspective view of a magnetic disk drive according to an embodiment of the present invention. A cover is detached to show interior of the magnetic disk drive.

A spindle motor is mounted on the base 1. The magnetic disk 2 is attached to the spindle and rotatably supported. The head stack assembly (hereinafter referred to as HSA) 3 and the voice coil motor (hereinafter referred to as VCM) 4 are mounted on the base 1. Further, there is provided the ramp 5 for unloading a head to outside of the magnetic disk 2 when the magnetic disk drive is stopped or read or write operation is suspended.

FIG. 2 is a perspective view of the head stack assembly (HSA) 3. The HAS 3 includes the head gimbal assembly (hereinafter referred to as HGA) 10, the voice coil 11 and a wiring connection section, which integrally swing about the bearing unit 13 as a swing center. The voice coil 11 constitutes a part of the VCM 4. The HAS 3 is swung by the VCM 4, and is configured in a manner that the head incorporated in the slider attached to the end of the HAS 3 can access a predetermined position on the magnetic disk 2, radially intersecting the magnetic disk 2. The wiring connection unit is electrically connected from the proximal end of the arm 15 to the magnetic head incorporated in the slider 17 supported by the suspension 16 and to the voice coil 11. The tab (lift tab) 18 is formed on the tip end of the suspension 16.

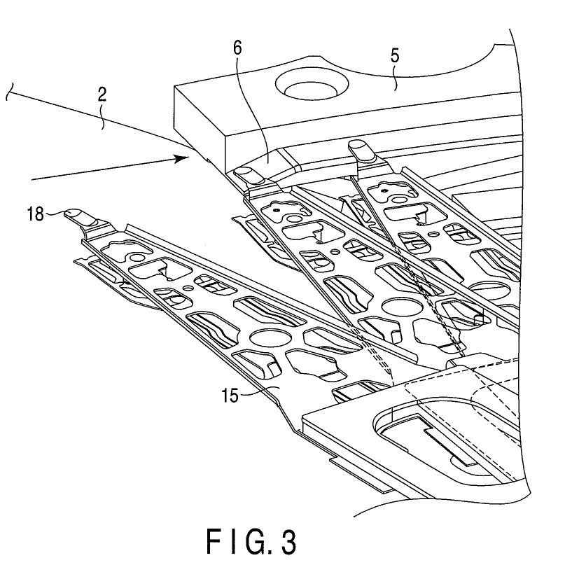

FIG. 3 is a perspective view sowing appearance of the ramp as a load/unload mechanism. The ramp 5 is positioned such that a part of the ramp 5 including a ramp edge 6 overlaps the magnetic disk 2. During unload operation of the magnetic head, the HGA 10 tracking over the magnetic disk 2 moves toward the ramp 5 by driving torque of the VCM 4. As a tab 18 on the tip end of the HGA 10 lifts up the slope of the ramp edge 6 in a sliding manner, the magnetic head can be unloaded from the magnetic disk 2.

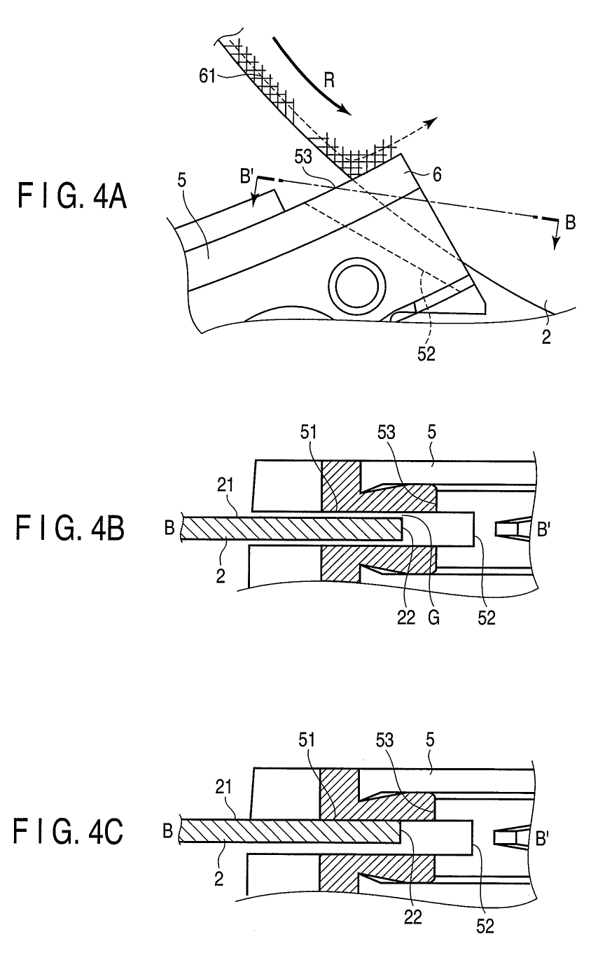

A problem of a magnetic disk drive using a conventional ramp will now be described. FIG. 4A is a plan view of a conventional ramp and magnetic disk. FIGS. 4B and 4C are cross-sectional views sectioned along the line B-B′ in FIG. 4A.

As shown in FIGS. 4A to 4C, a part of the ramp 5 including the ramp edge 6 overlaps the magnetic disk 2. As shown in FIG. 4B, the ramp 5 comprises the first counter surface 51 opposed to the peripheral part of the recording surface 21 of the magnetic disk 2, and the second counter surface 52 opposed to the edge surface 22 of the magnetic disk 2. A certain gap G within a range afforded by a whole height dimension of the apparatus is provided between the recording surface 21 of the magnetic disk 2 and the first counter surface 51 of the ramp 5.

As shown in FIG. 4C, when strong impact externally acts on the magnetic disk drive, the magnetic disk 2 may bend and collide with the first counter surface 51. Due to the impact, the rotating magnetic disk 2 may grind the ramp 5. Thus, as shown in FIG. 4A, ground dust 61 may stick to the peripheral part of the magnetic disk 2. If impact acts again in this situation, the ground dust 61 sticking to the peripheral part of the magnetic disk 2 scatters onto the inner recording surface of the magnetic disk 2 along the side surface 53 facing to the rotating direction R of the magnetic disk 2, as denoted by the arrow of the broken line.

During read/write operations of the magnetic disk drive, the magnetic head flies over the magnetic disk 2 by several nanometers to ten nanometers. Therefore, if the ground dust 61 exists on the recording surface of the magnetic disk 2, the magnetic head may catch the ground dust 61 which causes the magnetic head and the magnetic disk 2 to fail.

The magnetic disk apparatus according to the embodiment of the invention prevents ground dust 61 sticking to the peripheral part of the magnetic disk 2 from scattering toward the inner region of the disk upon further impact.

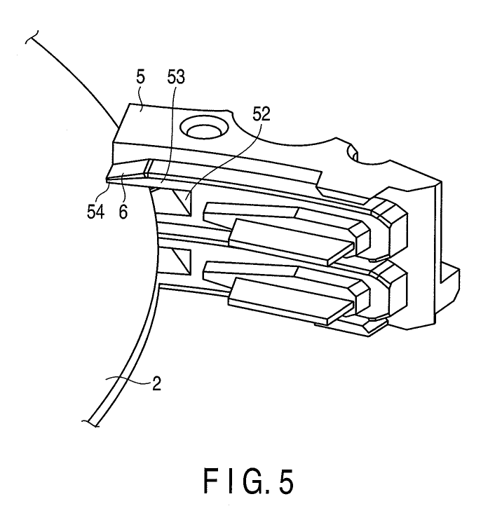

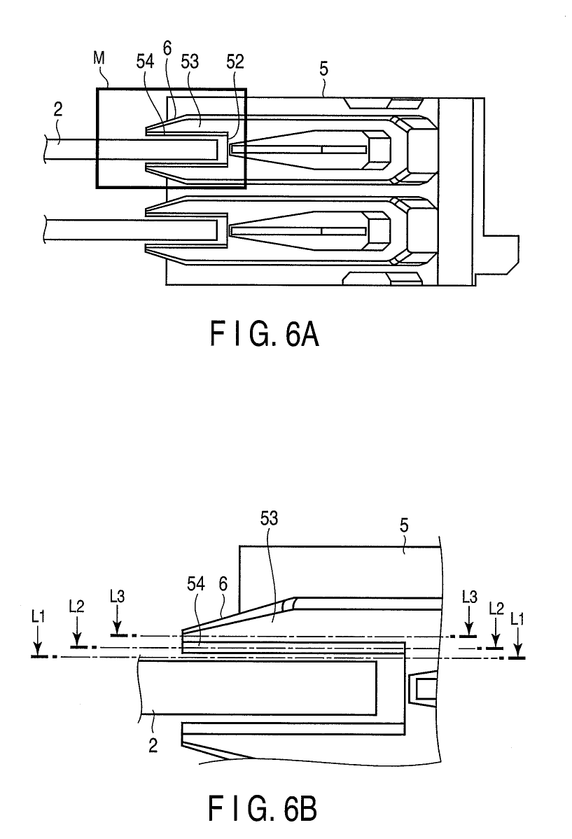

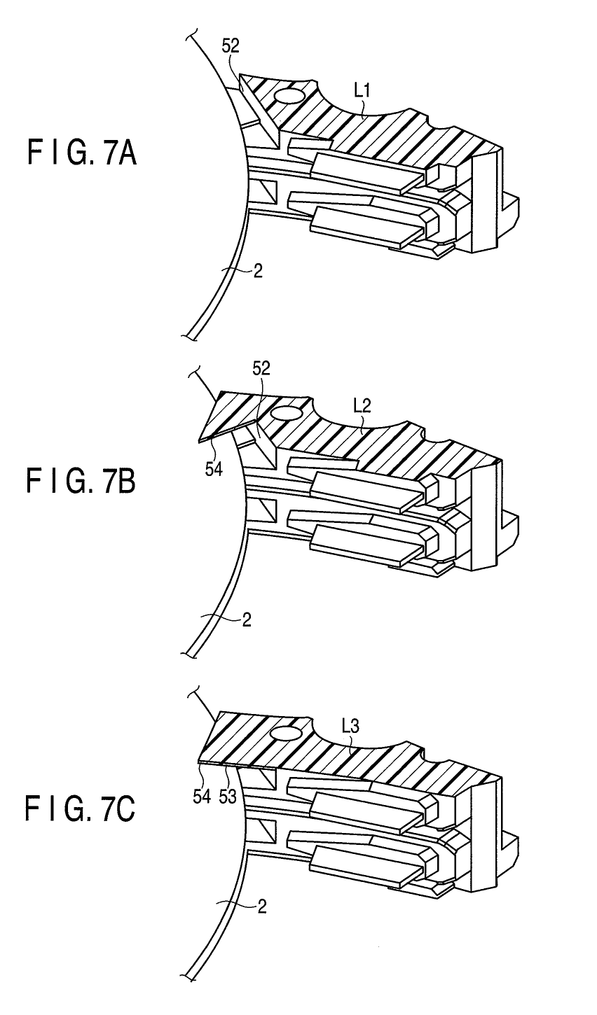

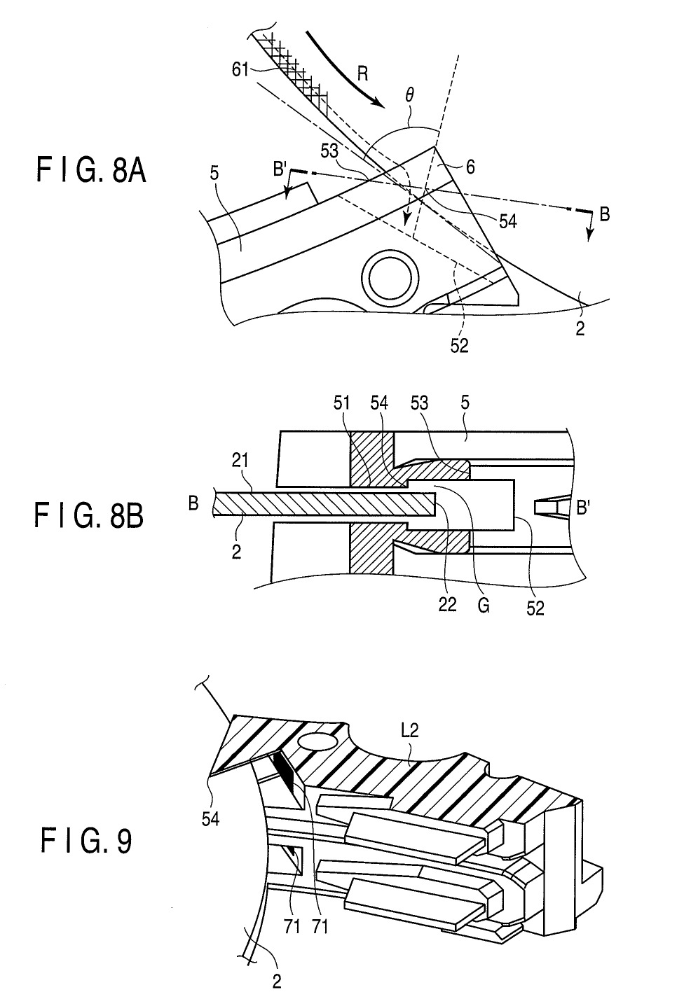

FIG. 5 is a perspective view showing the ramp and magnetic disk according to an embodiment of the invention. FIG. 6A is a side view of the ramp according to the present embodiment. FIG. 6B is an enlarged view of a part surrounded by frame M in FIG. 6A. FIGS. 7A, 7B, and 7C are perspective views of the ramp according to the present embodiment, sectioned along levels L1, L2, and L3, respectively. FIG. 8A is a plan view of the ramp and magnetic disk according to the present embodiment. FIG. 8B is a cross-sectional view sectioned along the line B-B′ in FIG. 8A.

As shown in these drawings, a part of the ramp 5 including the ramp edge 6 overlaps the magnetic disk 2 in the present embodiment as well.

The ramp 5 comprises the first counter surface 51 opposed to the peripheral part of the recording surface 21 of the magnetic disk 2, and the second counter surface 52 opposed to the edge surface 22 of the magnetic disk 2. Further, the ramp 5 comprises the side surface 53 which is adjacent to the first counter surface 51 and faces to the rotating direction R of the magnetic disk 2, and a part of the side surface 54 recessed toward the downstream side in the rotating direction R (hereinafter the part of the side surface 54 is referred to as the recessed side surface 54). The side surface 53 positioned more distant from the magnetic disk 2 than the recessed side surface 54 is formed in the same manner as in FIGS. 4A-4C. The recessed side surface 54 will be fully understood by referring to FIG. 7B showing the ramp according to the present embodiment, sectioned along the level L2 in FIG. 6B. The side surface 53 will be fully understood by referring to FIG. 7C showing the ramp according to the present embodiment, sectioned along the level L3 in FIG. 6B. In the present embodiment, an acute angle θ is formed between the recessed side surface 54 and a tangent line to the outer circumference of the magnetic disk 2. This tangent line is drawn through the intersection point between the recessed side surface 54 and the outer circumference of the magnetic disk 2, as shown in FIG. 8A.

In the present embodiment, when strong impact externally acts on the magnetic disk drive, the magnetic disk 2 may bend and collide with the first counter surface 51 of the ramp 5, as in the conventional apparatus. Due to the impact, the rotating magnetic disk 2 may grind the ramp 5, and the ground dust 61 may stick to the peripheral part of the magnetic disk 2.

In the present embodiment, even if impact acts again in this situation, the ground dust 61 moves toward the outside of the magnetic disk 2 because an acute angle is formed between the recessed side surface 54 and the tangent line to the outer circumference of the magnetic disk 2. In this manner, the ground dust 61 is prevented from scattering onto the inner recording surface of the magnetic disk 2. Accordingly, the magnetic head and the magnetic disk 2 can be prevented from failure due to the ground dust 61 caught by the magnetic head during read/write operations of the magnetic disk drive.

Although the present embodiment describes a case where the recessed side surface 54 is a flat surface, the recessed side surface 54 may be a curved surface.

FIG. 9 is a perspective view showing the ramp and magnetic disk in a magnetic disk drive according to another embodiment of the present invention, sectioned along a level L2 in FIG. 6B.

In case of applying the present invention, an area in the ramp 5 on which the ground dust 61 most scatters is considered to be the second counter surface 52 around a position where the recessed side surface 54 intersects. In FIG. 9, the resin layer 71 such as an adhesive seal is provided in the vicinity of that position. As a result, the resin layer 71 catches the ground dust 61 and prevents the ground dust 61 from scattering onto the inner recording surface of the disk.

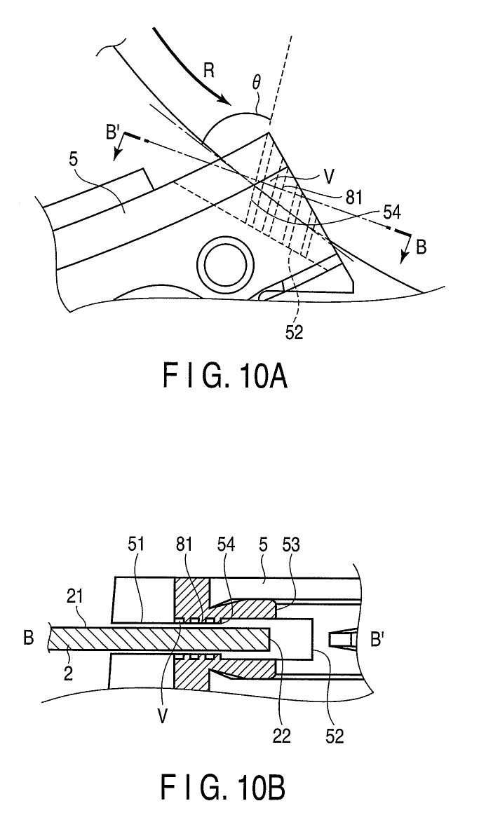

FIG. 10A is a plan view of the ramp and magnetic disk in still another embodiment of the present invention. FIG. 10B is a cross-sectional view sectioned along the line B-B′ in FIG. 10A.

The ramp according to the present embodiment comprises one or more grooves V in a first counter surface 51 in the downstream side in a rotating direction R of the magnetic disk 2 relative to the recessed side surface 54. An acute angle is formed between the wall surface 81 in each of the one or more grooves V and a tangent line to the outer circumference of the magnetic disk 2. In FIGS. 10A and 10B, the recessed side surface 54 and each wall surface 81 are formed parallel to each other. In the present embodiment, even if some factor hinders the ground dust 61 of the ramp 5 from being moved toward the outside of the magnetic disk 2 along the recessed side surface 54, possibility of moving the ground dust 61 toward the outside of the magnetic disk 2 along the wall surfaces 81 of the grooves can be enhanced.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic disk drive comprising:
a magnetic disk comprising a recording surface, the magnetic disk being supported and configured to rotate;
a head gimbal assembly comprising a slider comprising a head and a tab, the head gimbal assembly being configured to cause the head to access the recording surface of the magnetic disk; and
a ramp in a vicinity of the magnetic disk, the ramp comprising a first counter surface facing a peripheral portion of the magnetic disk, a second counter surface facing an edge surface of the magnetic disk, and a ramp edge configured to cause the tab of the head gimbal assembly to slide,
wherein the ramp comprises a portion of a side surface next to the first counter surface and facing to a rotating direction of the magnetic disk, and is recessed toward a downstream side in the rotating direction of the magnetic disk, and wherein the portion of the side surface recessed and a tangent line to an outer circumference of the magnetic disk form an acute angle.

2. The magnetic disk drive of claim 1, wherein the ramp further comprises an adhesive resin layer on the second counter surface crossing the recessed portion of the side surface.

3. The magnetic disk drive of claim 1, wherein the ramp further comprises at least one groove on the first counter surface in a downstream side in the rotating direction of the magnetic disk relative to the recessed portion of the side surface, and wherein a wall surface in the at least one groove and the tangent line to the outer circumference of the magnetic disk form an acute angle.
